(19) United States
(12) Patent Application Publication
(10) Pub. No.: US 2012/0253860 A1
(43) Pub. Date: Oct. 4, 2012

(54) METHODS FOR DECISION MAKING THROUGH CONVEX HULL OPTIMIZATION AND DEVICES THEREOF

(75) Inventor: Sheela SIDDAPPA, Bangalore (IN)

(73) Assignee: INFOSYS TECHNOLOGIES, LTD., Bangalore (IN)

(21) Appl. No.: 13/221,483

(22) Filed: Aug. 30, 2011

(30) Foreign Application Priority Data
Mar. 31, 2011 (IN) 1059/CHE/2011

(51) Int. Cl. G06Q 10/00

(52) U.S. Cl. 705/7.11

(57) ABSTRACT

Described are methods, systems, and computer-readable storage media for decision making through convex hull optimization. A plurality of key performance indicators (KPIs) are received. A convex hull encompassing the plurality of KPIs is generated. Based at least in part on the generated convex hull and on at least one KPI satisfying a condition, an operating range of one or more other KPIs is determined. Moreover, specific values at which each of the other KPIs may be maintained in order to reach a defined objective are determined.

This application claims the benefit of Indian Patent Application Filing No. 1059/CHE/2011, filed Mar. 31, 2011, which is hereby incorporated by reference in its entirety.

### FIELD

This technology generally relates to methods for decision making through convex hull optimization and devices thereof.

### BACKGROUND

Workbenches, e.g., Infosys® Procurement Workbench, are commonly utilized amongst industries to automate their work processes and assist in decision making. Such workbenches provide visibility into an organization's spending and enable buyers to streamline the processing of enquiries and orders. Workbenches allow a chief procurement officer (CPO) to delegate decisions to subordinate managers using an online tool. The managers in turn can set goals for their subordinates in the system. Workbenches can enable users to track the progress of the work and keep the system updated.

Existing workbenches do not, however, assist CPOs or managers with advanced analytical features such as recommendations on decision-making and the possible after-effects of implementing the recommended decision. That is, existing workbenches do not directly inform management of what decisions to make, much less articulate what decisions are optimal in light of all the (internal) factors. Moreover, existing workbenches do not account for the influence of external factors (e.g., oil prices, weather) on the procurement and/or planning process.

### SUMMARY

The concepts described herein involve decision making technology utilizing convex hull optimization. This technology can efficiently accommodate nearly all the constraints a CPO or manager may need to consider when making decisions affecting various business processes (e.g., procurement and planning). Beneficially, this technology can assist and guide CPOs or managers with their decision making duties and with setting appropriate and feasible goals for their subordinates.

In one aspect, there is a method for decision making through convex hull optimization. The method includes receiving, at a decision-making computing device, a plurality of key performance indicators (KPIs). A convex hull encompassing the plurality of KPIs is generated by the decision-making computing device. Based at least in part on the generated convex hull and on at least one KPI satisfying a condition, an operating range of one or more other KPIs is determined by the decision-making computing device.

In another aspect, there is a computer-readable storage medium having stored thereon instructions for decision making through convex hull optimization comprising machine executable code which, when executed by at least one processor, causes the processor to perform steps including the method described above.

In yet another aspect, there is a decision-making computing device including one or more processors and a memory coupled to the one or more processors which are configured to execute programmed instructions stored in the memory, the programmed instructions including the method described above.

In some embodiments, the plurality of KPIs include an internal KPI, an external KPI, a response KPI, or any combination thereof. In some of these embodiments, the plurality of KPIs include at least one response KPI. In some such embodiments, the determining of the operating range of the one or more other KPIs is based at least in part on the generated convex hull and on a response KPI satisfying a condition.

In some embodiments, the determining of the operating range of the one or more other KPIs involves optimizing an objective function with the at least one KPI as a variable, subject to constraints of the generated convex hull and to the condition. In some of these embodiments, optimizing includes minimizing the objective function, maximizing the objective function, or both, subject to the constraints of the generated convex hull and to the condition. In some embodiments, the condition is a restriction on an operating range of the at least one KPI.

Some implementations include any of the above-described aspects featuring any of the above embodiments or benefits thereof. These and other features will be more fully understood by reference to the following description and drawings, which are illustrative and not necessarily to scale.

### BRIEF DESCRIPTION OF THE DRAWINGS

FIG. 1 is an exemplary system environment that implements and executes the novel system and method of the present disclosure;

FIG. 2A is a block diagram of a client device shown in FIG. 1;

FIG. 2B is a block diagram of a server device shown in FIG. 1;

FIGS. 3A-3B are block diagrams of an exemplary KPI network;

FIG. 4 is flowchart of an exemplary method for decision making through convex hull optimization;

FIG. 5 is a flowchart of an exemplary method by which an operating range of one or more other KPIs can be determined, based at least in part on a generated convex hull and on at least one KPI satisfying a condition;

FIG. 6 is an exemplary two-dimensional convex hull, subject to a condition.

FIG. 7 is the exemplary two-dimensional convex hull of FIG. 6, subject to a different condition; and

FIGS. 8-9 are screenshots of an exemplary graphical user interface which incorporates the methods depicted in FIGS. 4-5.

### DETAILED DESCRIPTION

This technology is directed to methods, systems, and computer-readable storage media for decision making through convex hull optimization. Such decision making through convex hull optimization may occur, for example, in the context of business processes (e.g., business procurement processes).

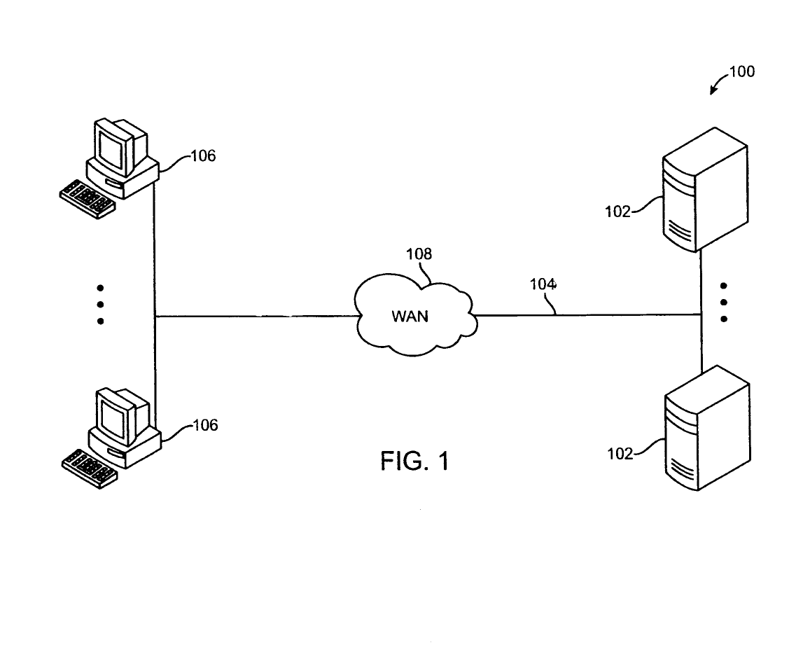

Referring now to FIG. 1, an example system environment 100 that includes one or more servers 102, such as a Web application server, and one or more client devices 106, although the environment 100 could include other numbers and types of devices in other arrangements. The web application servers 102 are connected to a local area network (LAN) 104 and the client devices 106 to a wide area network 108 in which the client devices 106 communicate with the Web application servers 102 via the wide area network 108. It should be noted that although more than one client device 106 and server 102 are shown in FIG. 1, any number of client devices 106, including only one, as well as any number of servers 102, including only one, are contemplated. It should also be noted that although client device and/or server may be referred to in the plural within the specification, it is contemplated that only one client device and/or one server may be considered without being limiting to the language used herein. It should be understood that the devices and the particular configuration shown in FIG. 1 are provided for exemplary purposes only and thus are not limiting.

Client devices 106 comprise computing devices capable of connecting to other computing devices, such as the Web application servers 102. Such connections are performed over wired and/or wireless networks, such as network 108, to send and receive data, such as for Web-based requests, receiving responses to requests and/or performing other tasks, in accordance with the novel processes described herein. Non-limiting and non-exhausting examples of such devices include personal computers (e.g., desktops, laptops), mobile and/or smart phones, kiosks, personal tablets, PDAs and the like. In one example, client devices 106 may be configured to run a Web browser that may provide an interface for operators, such as human users, to interact with for making requests for resources from one or more web server-based applications or Web pages via the network 108. It should be noted that it is contemplated that other server resources may be requested by the client devices 106. One or more Web-based applications may run on the web application servers 102 that provide the requested data back to one or more exterior network devices, such as client devices 106.

Network 108 comprises a publicly accessible network, such as the Internet, which includes client devices 106. However, it is contemplated that the network 108 may comprise other types of private and public networks that include other devices. Communications, such as requests from clients 106 and responses from servers 102, take place over the network 108 according to standard network protocols, such as the HTTP and TCP/IP protocols in this example. However, the principles discussed herein are not limited to this example and can include other protocols.

Further, it should be appreciated that network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs and other networks to enable messages and other data to be sent from and to network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts. In essence, the network 108 includes any communication method by which data may travel between client devices 106 and the Web application servers 102, and the like.

LAN 104 may comprise one or more private and public networks which provide secured access to the servers 102. Networks, including local area networks, besides being understood by those skilled in the relevant arts, have already been generally described above in connection with network 108 and thus will not be described further.

Web application server 102 comprises one or more server computing machines capable of operating one or more Web-based applications that may be accessed by network devices (e.g. client devices, other servers) in the network 108. Such network devices include client devices 106 which may provide other data representing requested resources, such as particular Web page(s), image(s) of physical objects, and any other objects, responsive to the requests. It should be noted that the server 102 may perform other tasks and provide other types of resources. It should be noted that one or more of the Web application servers 102 may be a cluster of servers managed by a network traffic management device, gateway device, router, hub and the like.

As per the TCP/IP protocols, requests from the requesting client devices 106 may be sent as one or more streams of data packets over network 108 to the Web application servers 102. Such protocols can establish connections, send and receive data for existing connections, and the like. It is to be understood that the one or more Web application servers 102 may be hardware and/or software, and/or may represent a system with multiple servers that may include internal or external networks. In this example, the Web application servers 102 may be any version of Microsoft® IIS servers, RADIUS servers and/or Apache® servers, or any other suitable servers. Further, additional servers may be coupled to the network 108, and many different types of applications may be available on servers coupled to the network 108.

Each of the Web application servers 102 and client devices 106 may include one or more central processing units (CPUs), one or more computer readable media (i.e., memory), and interface systems that are coupled together by internal buses or other links as are generally known to those of ordinary skill in the art.

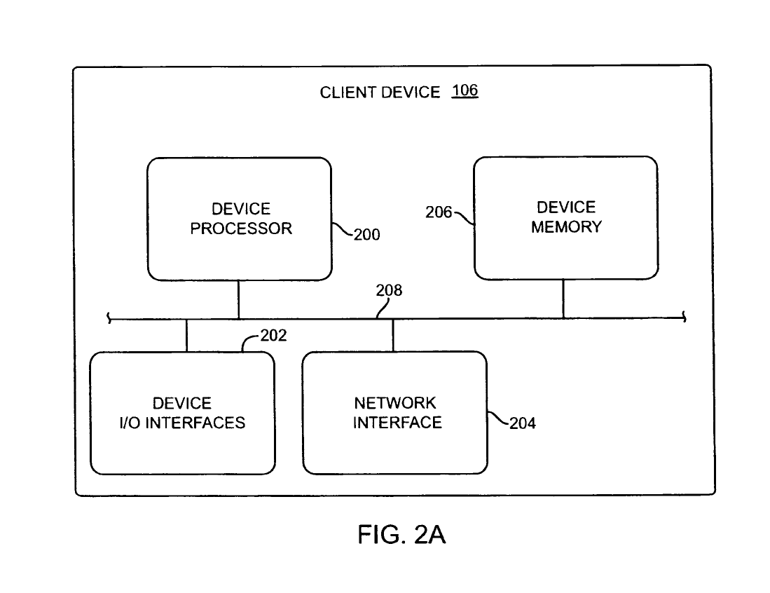

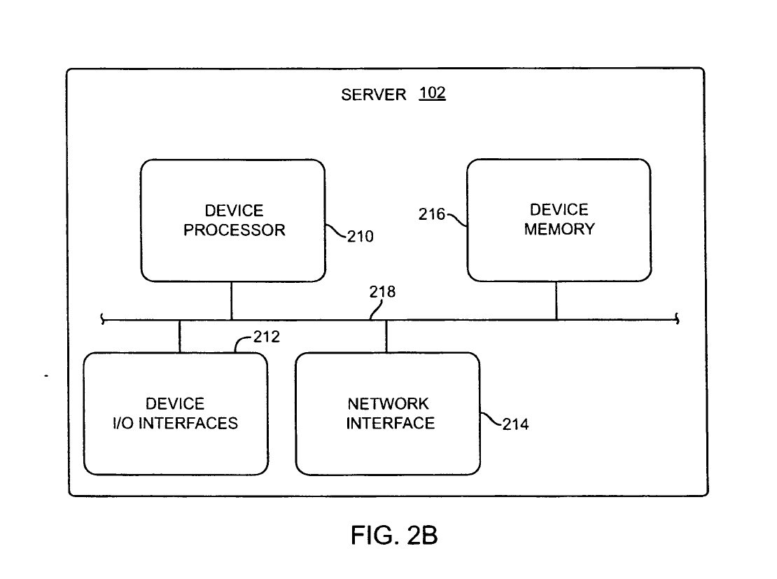

Referring now to FIG. 2A, an example client device 106 includes one or more device processors 200, one or more device I/O interfaces 202, one or more network interfaces 204, and one or more device memories 206, all of which are coupled together by one or more buses 208. It should be noted that the device 106 could include other types and numbers of components. Additionally, with regard to FIG. 2B, an example server 102 is shown which includes one or more device processors 210, one or more device I/O interfaces 212, one or more network interfaces 214, and one or more device memories 216, all of which are coupled together by one or more buses 218. It should be noted that the server 102 could include other types and numbers of components.

Device processor 200, 210 comprises one or more microprocessors configured to execute computer/machine readable and executable instructions stored in the device memory 206, 216. Such instructions are implemented by the client device 106 and/or server 102 to perform the functions described below. It is understood that the processor 200, 210 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200, 210 is programmed or configured to execute the process in accordance with the teachings as described and illustrated herein with respect to novel method described below.

Device I/O interfaces 202, 212 comprise one or more user input and output device interface mechanisms. The interface may include a computer keyboard, mouse, display device, and the corresponding physical ports and underlying supporting hardware and software to enable communication with other devices over the network 108. Such communications may include, but are not limited to, accepting user data input and providing output information to a user, programming and administering one or more functions to be executed by the corresponding device and the like.

Network interface 204, 214 comprises one or more mechanisms that enable the client device 106 and/or the server 102 to engage in TCP/IP communications over LAN 104 and network 108. However, it is contemplated that the network interface 204, 214 may be constructed for use with other communication protocols and types of networks. Network interface 204, 214 is sometimes referred to as a transceiver, transceiving device, or network interface card (NIC), which transmits and receives network data packets to one or more networks, such as LAN 104 and network 108. In an example where the client device 106 and/or server 102 includes more than one device processor 200, 210 (or a processor 200, 210 has more than one core), each processor 200, 210 (and/or core) may use the same single network interface 204, 214 or a plurality of network interfaces 204, 214. Further, the network interface 204, 214 may include one or more physical ports, such as Ethernet ports, to couple its respective device with other network devices in the system 100. Moreover, the interface 204, 214 may include certain physical ports dedicated to receiving and/or transmitting certain types of network data, such as device management related data for configuring the respective device.

Bus 208, 218 may comprise one or more internal device component communication buses, links, bridges and supporting components, such as bus controllers and/or arbiters. The bus enables the various components of the device 102, 106, such as the processor 200, 210, device I/O interfaces 202, 212, network interface 204, 214, and device memory 206, 216, to communicate with one another. However, it is contemplated that the bus may enable one or more components of its respective device 102, 106 to communicate with components in other devices as well. Example buses include HyperTransport, PCI, PCI Express, InfiniBand, USB, Firewire, Serial ATA (SATA), SCSI, IDE, and AGP buses. However, it is contemplated that other types and numbers of buses may be used, whereby the particular types and arrangement of buses will depend on the particular configuration of the device 102, 106 which houses the bus.

Device memory 206, 216 of the client device 106 or server 102 comprises computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media contains computer readable/machine-executable instructions, data structures, program modules, or other data, which may be obtained and/or executed by one or more processors, such as device processor 200, 210. Such instructions allow the processor to perform actions, including implementing an operating system for controlling the general operation of the client device 106 and/or server 102 to perform one or more portions of the novel process described below.

Examples of computer readable storage media include RAM, BIOS, ROM, EEPROM, flash/firmware memory, or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by a computing or specially programmed device 102, 106.

Although an example of the server 102 and the client device 106 is described and illustrated herein in connection with FIGS. 1 and 2A-2B, each of the computers of the system 100 could be implemented on any suitable computer system or computing device. It is to be understood that the example devices and systems of the system 100 are for exemplary purposes, as many variations of the specific hardware and software used to implement the system 100 are possible, as will be appreciated by those skilled in the relevant art(s). Furthermore, each of the devices of the system 100 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like. The devices may be programmed according to the teachings as described and illustrated herein, as will be appreciated by those skilled in the computer, software, and networking arts.

In addition, two or more computing systems or devices may be substituted for any one of the devices in the system 100. Accordingly, principles and advantages of distributed processing, such as redundancy, replication, and the like, also can be implemented, as desired, to increase the robustness and performance of the devices and systems of the system 100. The system 100 may also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

The present disclosure involves decision making technology utilizing convex hull optimization. This technology can efficiently accommodate nearly all the constraints a CPO or manager may need to consider when making decisions affecting various business processes (e.g., procurement and planning). Beneficially, this technology can assist and guide CPOs or managers with their decision making duties and with setting appropriate and feasible goals for their subordinates.

In any given industry, there may be numerous (e.g., 500-1000) key performance indices or KPIs which may affect decisions that need to be made in various aspects of the business. For example, in the procurement planning area, attempting to constrain or fix future total spending, sales, revenue, etc. is dependent on such internal KPIs as the number of suppliers, invoice amounts, as well as on external KPIs such as oil prices and climate conditions. Attempting to understand the functional relationship amongst these internal and external KPIs, much less constrain the response of particular KPIs, is certainly a daunting task without some means for quantifying these relationships. For the purposes of this disclosure, we will refer to those KPI values which we want to constrain in some manner as “response KPIs.”

While a regression function may help generate only one functional relation between a response KPI and other related internal and external KPIs, use of the response KPI within a convex hull will identify and generate many possible relationships.

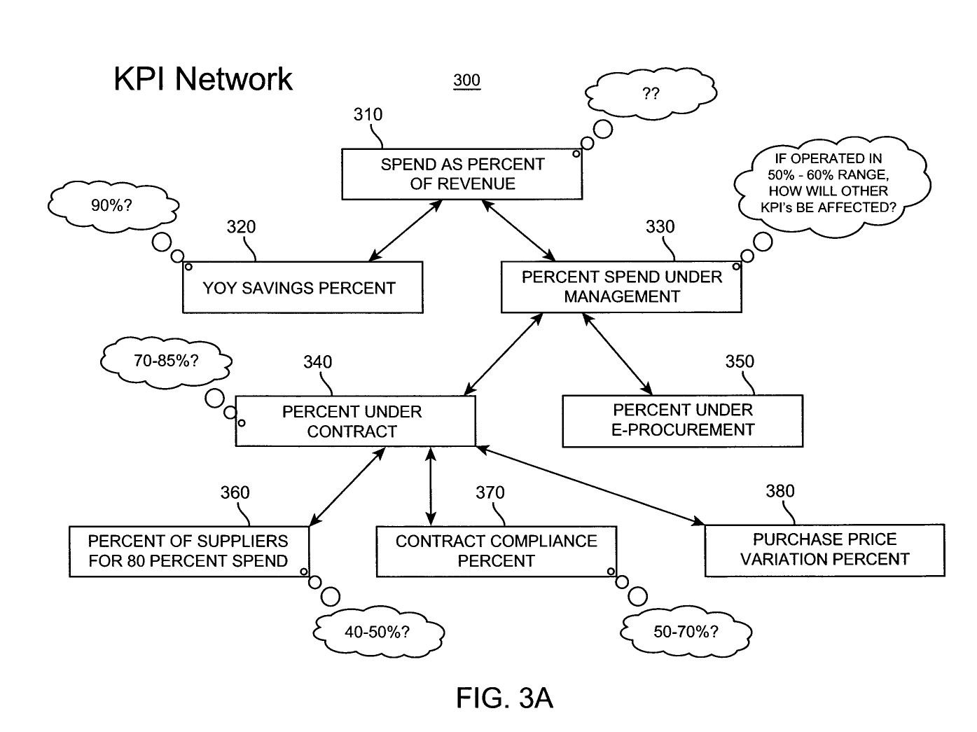

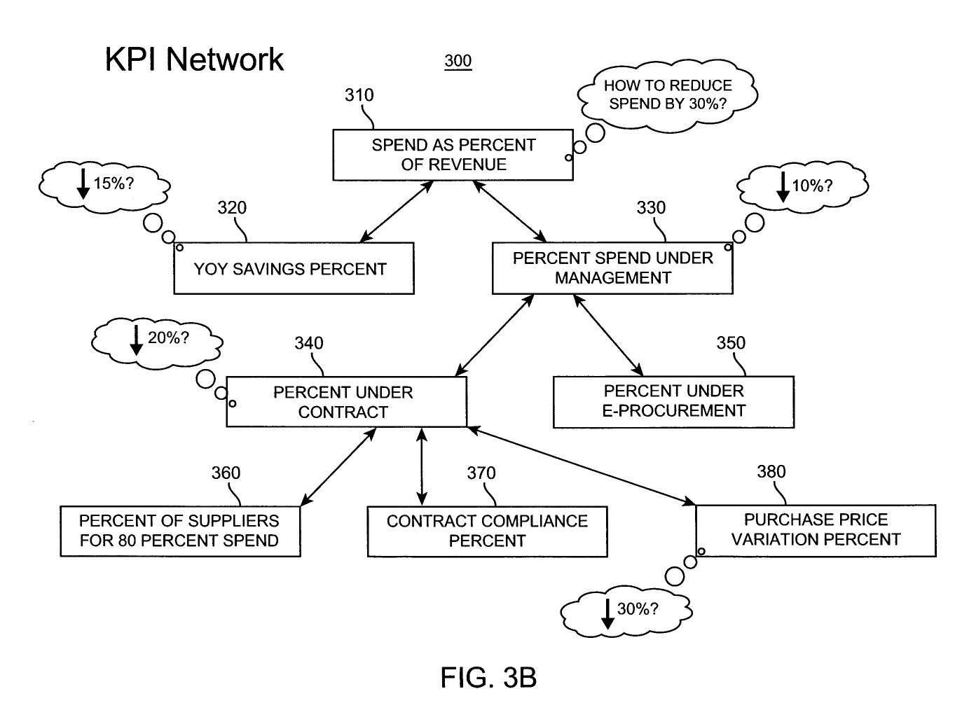

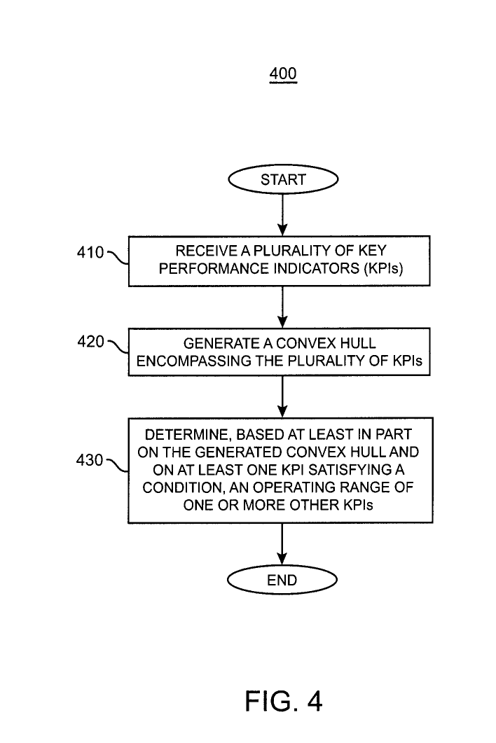

FIGS. 3A-3B are block diagrams of an exemplary KPI network 300, with KPIs 310-380 and their interconnections depicted therein. FIG. 3A poses the question that if the percentage spent under management (response KPI 330) is reduced to 50%-60% of that spent last year, how will the other KPIs (310-320 and 340-380) be affected? An alternative scenario in FIG. 3B queries that if total spending (response KPI 310) has to be reduced by 30% from last year, what range must the other KPIs (320-380) operate in to accomplish that goal? An exemplary method by which both questions may be answered is depicted in FIG. 4.

FIG. 4 is a flowchart depicting an exemplary method 400 for decision making through convex hull optimization. With reference to FIGS. 1-2B, the method 400 includes a decision-making computing device 106 receiving a plurality of KPIs (block 410). These KPI's may be received, for example, over WAN 108 or LAN 104, and/or through any suitable input of device 106. In some embodiments, these KPIs may relate to a particular business process and include internal KPIs (e.g., KPIs that are more directly under the control of the business), external KPIs (e.g., KPIs that may be outside of the business's direct control, yet still relevant to the particular business process at issue, such as weather conditions, oil prices, supplier reliability, etc.), response KPIs, or any combination thereof. In some embodiments, the received KPIs may include at least one response KPI. The received KPIs may relate to any business strategy and/or business plan in an organization including, but not limited to, human resources (recruitment, employee development), finance, health and safety, environment (energy consumption, waste disposal), supply chain, procurement, distribution, housing, manufacturing, maintenance, and so on.

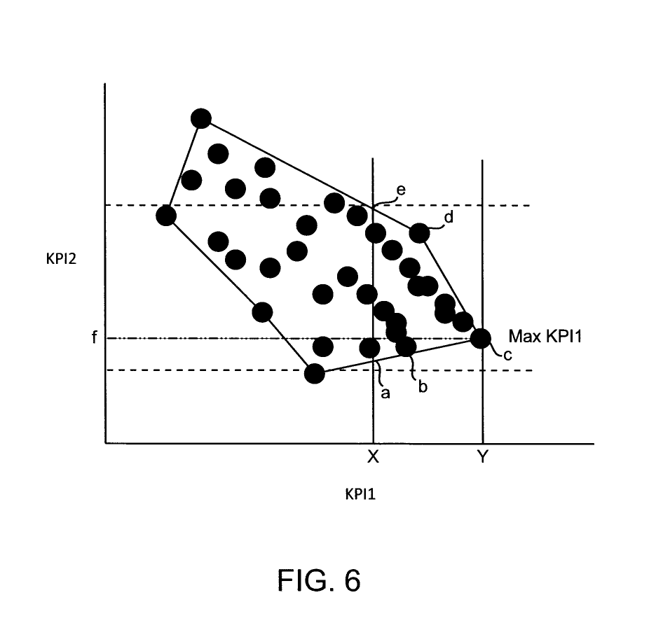

The decision-making computing device 106 generates a convex hull containing the received plurality of KPIs (block 420). A convex hull of a set of S points in a 2-dimensional plane is defined to be the smallest convex polygon that contains all the elements of S. An exemplary 2-dimensional convex hull is shown in FIG. 6.

The convex hull of a set of points S in d dimensions is the intersection of all convex sets containing S. For N points p₁, . . . , p_{N}, the convex hull C is given by the expression:

$$C = \{ {\sum }_{j = 1}^{N} {λ}_{j} {p}_{j} \vert {λ}_{j} \geq 0 ∀ j and {\sum }_{j = 1}^{N} {λ}_{j} = 1 \} .$$

If N data points corresponding to d KPIs are received, the decision-making computing device 106 may generate a d-dimensional convex hull. A d-dimensional convex hull may be computed using the Gift Wrapping algorithm, which has complexity O(N^{└d/2┘+1}). Alternatively or additionally, any suitable algorithm may be used to generate the convex hull including, but not limited to, the Quick Hull algorithm, Graham's Scan, and Chan's algorithm.

The decision-making computing device 106 determines, based at least in part on the generated convex hull and on at least one KPI satisfying a condition, an operating range of one or more other KPIs (block 430). In some embodiments, the condition may include a restriction on an operating range of the at least one KPI.

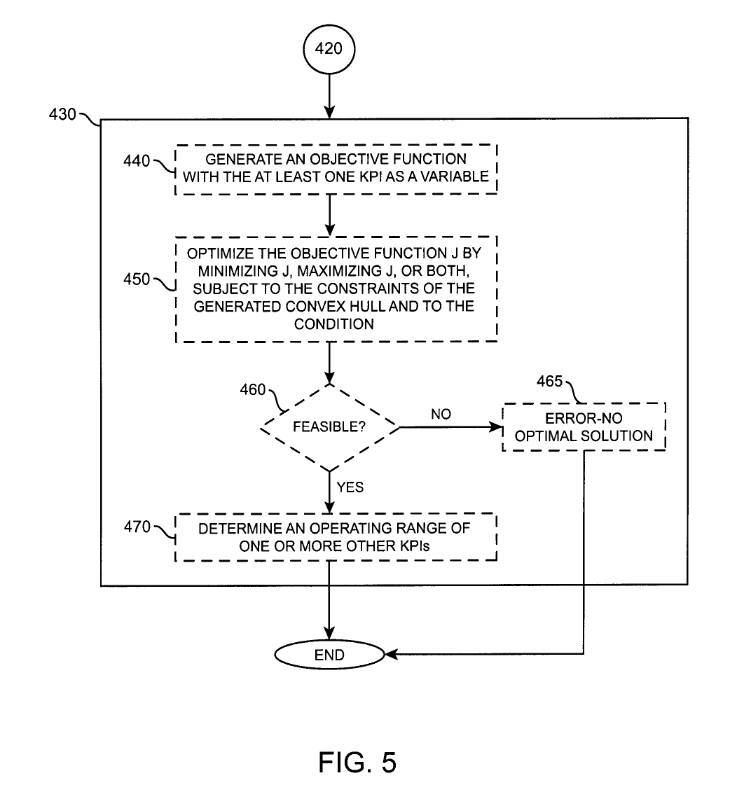

FIG. 5 is a flowchart of an exemplary method by which an operating range of one or more other KPIs can be determined, based at least in part on a generated convex hull and on at least one KPI satisfying a condition. Referring to FIG. 4, FIG. 5 depicts exemplary steps that may be included in block 430.

The decision-making computing device 106 may generate an objective function with the at least one KPI as a variable (block 440). For example, the decision-making computing device 106 may add the objective function(s) F=g(KPI_1 . . . KPI_n) within the set of constraints, and minimize F or maximize F. The objective function may therefore be deduced by considering the response KPI “F”, which may have one or more functional form, with other KPI's in block 410, and generating the functional forms. Hence, the decision-making computing device 106 may just have Minimize F or Maximize F as their objective, but the functional relation can be seen in the set of constraints. In some embodiments, the at least one KPI may be a response KPI.

The decision-making computing device 106 may then optimize the objective function subject to the constraints of the generated convex hull and to the condition (block 450). The intersection of the generated convex hull and the condition upon the at least one KPI results in a region which may or may not be “feasible” (block 460) for optimization. For example, generating a feasible region (block 460) may require that any constraints placed on the operating range of any of the KPIs lie within the available range of the convex hull—not outside of it.

For example, as depicted in FIG. 6, the 2-dimensional convex hull is intersected with the condition that X≦KPI1≦Y. This results in a feasible convex region abcdea (block 460). Consequently, the decision-making computing device 106 is able to make a determination as to the operating range of KPI2 (block 470). For example, if KPI1 is maximized subject to the aforementioned constraints, the value of KPI1 is Y and the corresponding value of KPI2 is f. Similarly, if this example were extended to more than two dimensions (e.g., three or more KPIs), maximizing KPI1 subject to the aforementioned constraints would yield requisite values for KPI3, KPI4, and so on. In this way, questions such as those posed by FIGS. 3A-3B can be easily solved.

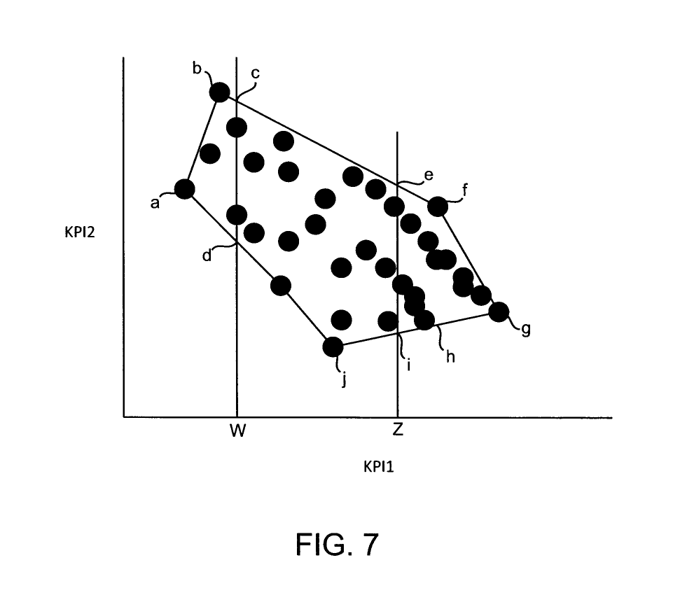

On the other hand, in FIG. 7, suppose that the 2-dimensional convex hull is intersected with the condition that KPI1<W and KPI1>Z. The resultant region consisting of abcda and efghie would not be feasible, as the convexity property is violated. Rather, the decision-making computing device 106 would provide an indication or error message that no optimal solution is possible under these constraints (block 465). If the conditions on KPI1 were instead solely KPI1<W; or W<KPI1<Z; or KPI1>Z, the resultant regions, abcda, or ceijdc, or efghie respectively would each be feasible; thus, block 465 would be avoided and optimization could be achieved. Such optimization may include minimizing the objective function, maximizing the objective function, or both to determine an operating range of one or more other KPIs.

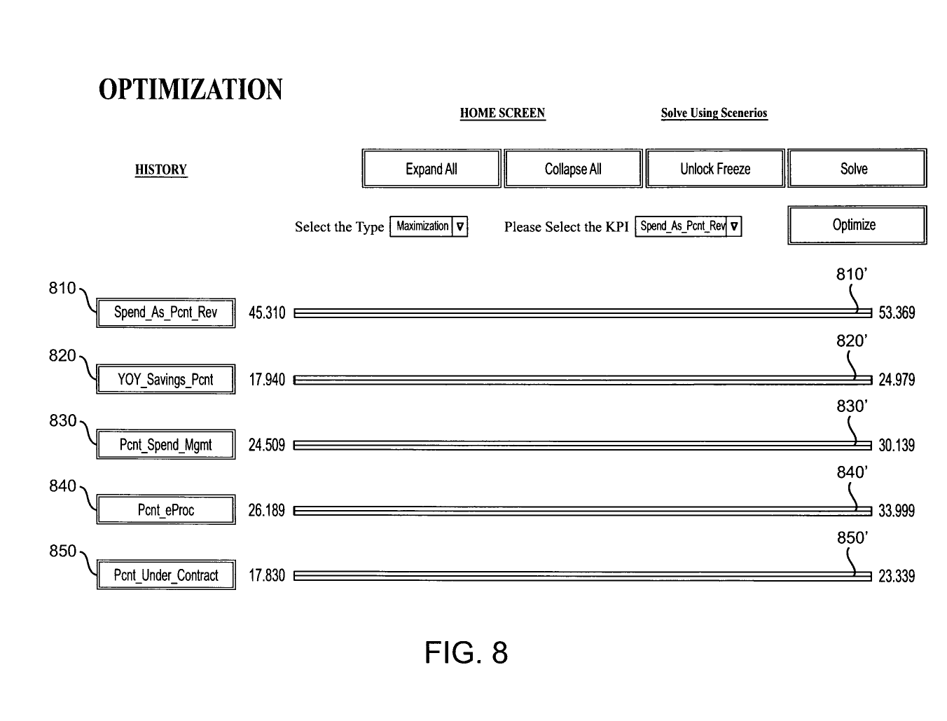

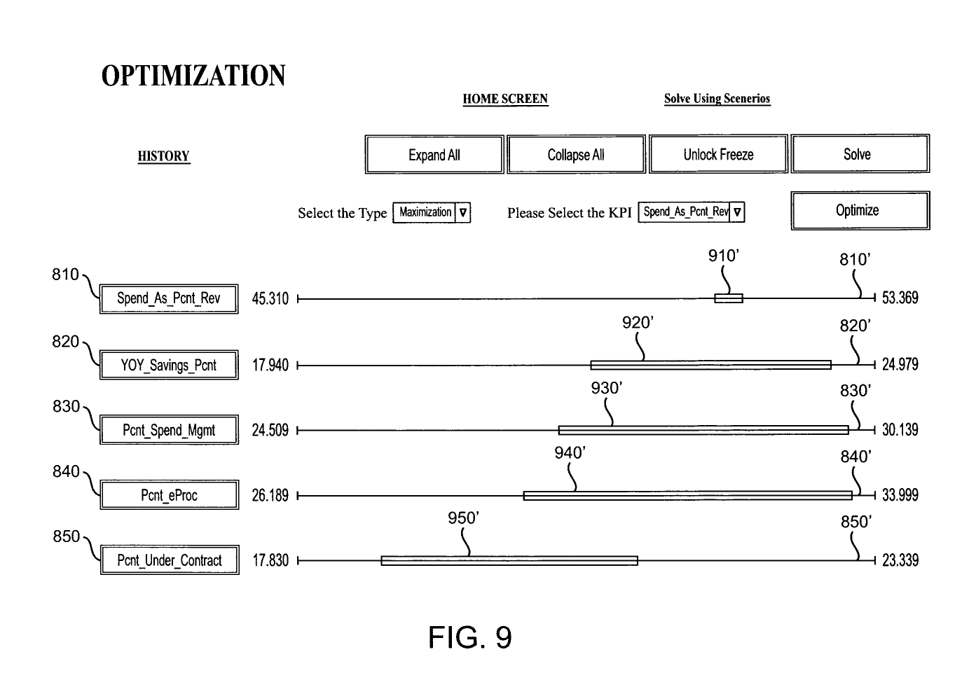

FIGS. 8-9 are screenshots of an exemplary graphical user interface which incorporates the methods depicted in FIGS. 4-5 and displays the results to a user. FIG. 8 depicts the convex hull constraint encompassing five KPIs 810-850 being graphically displayed. In particular, the operating range of each KPI 810-850, subject to the convex hull, is shown as an elongated horizontal bar 810′-850′. Alternatively, these ranges may be depicted as a vertical bar, numerically, or in any suitable way. Each bar 810′-850′ may be manipulated by a user (e.g., via a mouse) to select a desired range or condition for a particular KPI, which results in corresponding changes to the other KPIs.

For example, in FIG. 9, bar 810′ has been manipulated to constrain KPI 810 to a small portion 910′ of its possible operating range. Consequently, each of the bars 820′-850′ are automatically adjusted accordingly (e.g., to portions 920′-950′) to reflect what values of KPIs 820-850 will sustain the constraint placed upon KPI 810. Alternatively, these constrained ranges 910′-950′ may be depicted in any number of ways, including but not limited to, numerically or via vertical bars.

Alternatively or additionally, the methods depicted in FIGS. 4-5 may be incorporated into workbenches such as the Infosys® Procurement Workbench, or into any other suitable decision-making tool.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

We claim:

1. A method for decision making through convex hull optimization, the method comprising:
receiving, by a decision-making computing device, a plurality of key performance indicators (KPIs);
generating, by the decision-making computing device, a convex hull encompassing the plurality of KPIs; and
determining, by the decision-making computing device, based at least in part on the generated convex hull and on at least one KPI satisfying a condition, an operating range of one or more other KPIs.

2. The method of claim 1, wherein the plurality of KPIs comprise an internal KPI, an external KPI, a response KPI, or any combination thereof.

3. The method of claim 2, wherein the plurality of KPIs comprise at least one response KPI.

4. The method of claim 3, wherein determining further comprises:
determining, by the decision-making computing device, based at least in part on the generated convex hull and on a response KPI satisfying a condition, the operating range of one or more other KPIs.

5. The method of claim 1, wherein determining the operating range of the one or more other KPIs further comprises:
optimizing, by the decision-making computing device, an objective function with the at least one KPI as a variable, subject to constraints of the generated convex hull and to the condition.

6. The method of claim 5, wherein optimizing comprises minimizing the objective function, maximizing the objective function, or both, subject to the constraints of the generated convex hull and to the condition.

7. The method of claim 1, wherein the condition is a restriction on an operating range of the at least one KPI.

8. A computer-readable storage medium having stored thereon instructions for decision making through convex hull optimization comprising machine executable code which, when executed by at least one processor, causes the processor to perform steps comprising:
receiving a plurality of key performance indicators (KPIs);
generating a convex hull encompassing the plurality of KPIs; and
determining, based at least in part on the generated convex hull and on at least one KPI satisfying a condition, an operating range of one or more other KPIs.

9. The medium as set forth in claim 8, wherein the plurality of KPIs comprise an internal KPI, an external KPI, a response KPI, or any combination thereof.

10. The medium as set forth in claim 9, wherein the plurality of KPIs comprise at least one response KPI.

11. The medium as set forth in claim 10, wherein determining further comprises:
determining, based at least in part on the generated convex hull and on a response KPI satisfying a condition, the operating range of one or more other KPIs.

12. The medium as set forth in claim 8, wherein determining the operating range of the one or more other KPIs further comprises:
optimizing an objective function with the at least one KPI as a variable, subject to constraints of the generated convex hull and to the condition.

13. The medium as set forth in claim 12, wherein optimizing comprises minimizing the objective function, maximizing the objective function, or both, subject to the constraints of the generated convex hull and to the condition.

14. The medium as set forth in claim 8, wherein the condition is a restriction on an operating range of the at least one KPI.

15. A decision-making computing device comprising:
one or more processors; and
a memory coupled to the one or more processors which are configured to execute programmed instructions stored in the memory, the programmed instructions comprising:
receiving a plurality of key performance indicators (KPIs);
generating a convex hull encompassing the plurality of KPIs; and
determining, based at least in part on the generated convex hull and on at least one KPI satisfying a condition, an operating range of one or more other KPIs.

16. The device as set forth in claim 15, wherein the plurality of KPIs comprise an internal KPI, an external KPI, a response KPI, or any combination thereof.

17. The device as set forth in claim 16, wherein the plurality of KPIs comprise at least one response KPI.

18. The device as set forth in claim 17, wherein determining further comprises:
determining, based at least in part on the generated convex hull and on a response KPI satisfying a condition, the operating range of one or more other KPIs.

19. The device as set forth in claim 15, wherein determining the operating range of the one or more other KPIs further comprises:
optimizing an objective function with the at least one KPI as a variable, subject to constraints of the generated convex hull and to the condition.

20. The device as set forth in claim 19, wherein optimizing comprises minimizing the objective function, maximizing the objective function, or both, subject to the constraints of the generated convex hull and to the condition.

21. The device as set forth in claim 15, wherein the condition is a restriction on an operating range of the at least one KPI.
